(19) United States
(12) Patent Application Publication
(10) Pub. No.: US 2014/0001110 A1
(43) Pub. Date: Jan. 2, 2014

(54) MICROFLUIDIC FILTER USING THREE-DIMENSIONAL CARBON NANOTUBE NETWORKS AND PREPARATION METHOD THEREOF

(71) Applicants: Hai Won Lee, Seoul (KR); Bio Park, Seoul (KR); Jung Eun Seo, Seoul (KR); Simon Song, Seoul (KR)

(72) Inventors: Hai Won Lee, Seoul (KR); Bio Park, Seoul (KR); Jung Eun Seo, Seoul (KR); Simon Song, Seoul (KR)

(21) Appl. No.: 13/990,517

(22) PCT Filed: Oct. 25, 2011
(86) PCT No.: PCT/KR2011/007946

§ 371 Date: Sep. 12, 2013

(30) Foreign Application Priority Data
Nov. 30, 2010 (KR) 10-2010-0120323
Jul. 13, 2011 (KR) 10-2011-0069461

(51) Int. Cl. G01N 1/34; B01L 3/00

(52) U.S. Cl. CPC G01N 1/34; B01L 3/00; B82Y 99/00
USPC 210/323.2; 427/204; 977/750; 977/904; 977/843

(57) ABSTRACT

The present invention provides a microfluidic filter system using three-dimensional carbon nanotube networks. The density of the carbon nanotubes can be adjusted such that particles having a specific size can be filtered. In addition, the network structures can be maintained even in a fluid. The present invention also provides a method for preparing the microfluidic filter system.

### TECHNICAL FIELD

The present invention relates to a microfluidic filter using three-dimensional (3D) carbon nanotube networks and a method for preparing the same. More specifically, the present invention relates to a microfluidic filter that uses carbon nanotube networks whose density can be adjusted and whose three-dimensional structures are maintained in a fluid to enable the filtering of substances having a particular size.

### BACKGROUND ART

Carbon nanotubes are allotropes of carbon that consist of carbon, which is one of the most common elements on the earth. Carbon nanotubes are tubular materials in which carbon atoms are bonded to other adjacent carbon atoms in a hexagonal honeycomb pattern. Carbon nanotubes have an extremely small diameter in the nanometer range. Based on these structural characteristics, carbon nanotubes possess metal or semiconductor properties according to their diameters and rolled shapes. Under such circumstances, a great deal of research has been conducted on carbon nanotubes that can overcome the limited mechanical/electrical properties of conventional materials.

Particularly, single-walled carbon nanotube bridges suspended between two electrodes or templates, or three-dimensional networks thereof can be directly applied to electronic devices, including field emission displays (FEDs), nanotube interconnectors, and nanosensors, due to their excellent electrical properties such as high current density and ballistic conductance. Thus, numerous methods for preparing single-walled carbon nanotube bridges and three-dimensional networks thereof have been proposed.

In view of this situation, the present inventors have reported a method for preparing three-dimensional carbon nanotube networks with enhanced electron transfer efficiency (PCT/KR2009/003185). According to this method, carbon nanotubes are directly formed on a silicon substrate, which enables direct application of the three-dimensional carbon nanotube networks to an electronic device. In addition, the three-dimensional carbon nanotube networks can be densely formed even on silicon pillars or in nanoholes with a high aspect ratio. Since the three-dimensional carbon nanotube networks are formed by growth of uniformly dispersed carbon nanotubes, they have the advantage of a large reactive surface area where substances can be attached.

However, low strength of the carbon nanotube networks causes poor adhesion between the carbon nanotubes and the substrate. As a result, the carbon nanotubes are likely to be peeled off from the substrate in a fluid, which makes it difficult to apply the three-dimensional networks to a solution process.

In the case where carbon nanotube bundles are used, hydrophobic solutions only can be selectively used because of the hydrophobic surface of the carbon nanotubes. The bundles can separate solutes from solvents but are not suitable for the filtering of specific particles due to their uncontrolled pore size.

A lab-on-a-chip or a micro-total analysis system (micro-TAS) is used as a chip to determine and diagnose a disease in a medicine or micro-unit design test or a clinical test. The top portion of the chip can function to concentrate a sample having a particular size through purification and isolation after cell disruption. The bottom portion of the chip can be used as a filter where particles having a desired size can be purified after synthesis of substances. Filter systems using carbon nanotubes have been developed. For example, a carbon nanotube sheet on a two-dimensional planar structure was fabricated as a filter. However, since the filter has a non-uniform pore size and is hydrophobic, it is impossible to use the filter in various solutions without surface modification. Further, all substances having a size above the nanometer range as well as substances having a particular size are filtered by the filter. That is, the filtering ability of the filter substantially remains at a level to remove contaminants.

### DISCLOSURE

### Technical Problem

It is an object of the present invention to provide a microfluidic chip filter system that uses three-dimensional carbon nanotube networks whose density can be adjusted and whose three-dimensional structures are maintained in a fluid to enable the filtering of substances having a particular size, and a method for fabricating the microfluidic chip filter system.

### Technical Solution

According to an aspect of the present invention, there is provided a microfluidic filter including three-dimensional carbon nanotube networks coated with a metal oxide wherein the density of the three-dimensional carbon nanotube networks is adjustable such that the filtering size is controlled.

The three-dimensional carbon nanotube networks used in the microfluidic filter of the present invention grow horizontally in parallel between silicon pillars formed on a silicon substrate to form a plurality of carbon nanotube bridges. At least ten carbon nanotube bridges are preferably formed horizontally between the two adjacent silicon pillars to form the three-dimensional networks.

In one embodiment of the present invention, the metal oxide may be, for example, Al₂O₃, HfO₂, ZrO₂, ZnO₂, or CuOₓ.

According to another aspect of the present invention, there is provided a method for preparing a microfluidic filter using three-dimensional carbon nanotube networks. Specifically, the method includes: forming silicon pillars on a silicon substrate; dipping the silicon substrate in a bimetallic catalyst solution to allow the metal catalysts to be uniformly adsorbed onto the substrate; supplying a carbon source gas to the substrate onto which the catalysts are adsorbed, to form three-dimensional carbon nanotube networks between the silicon pillars; and coating a metal oxide on the three-dimensional carbon nanotube networks by atomic layer deposition, wherein the density of the three-dimensional carbon nanotube networks is adjusted by varying the height of the silicon pillars and the spacing between the silicon pillars such that the filtering size is controllable.

In one embodiment of the present invention, the bimetallic catalyst is preferably a Fe—Mo catalyst and the molar concentration ratio of Fe to Mo in the Fe—Mo catalyst solution is more preferably from 10:1 to 1:1.

In a further embodiment of the present invention, the method may further include annealing the substrate onto which the bimetallic catalyst is adsorbed, and supplying NH₃ or hydrogen gas to the annealed substrate to reduce the metal catalysts.

The carbon source gas may be selected from the group consisting of methane, ethylene, acetylene, benzene, hexane, ethanol, methanol, propanol, and mixed gases thereof.

### Advantageous Effects

The three-dimensional carbon nanotube networks used in the microfluidic filter of the present invention are formed by growth of uniformly dispersed carbon nanotubes. Therefore, the three-dimensional carbon nanotube networks have the advantage of large reactive surface area. In addition, the three-dimensional carbon nanotube networks coated with the metal oxide by atomic layer deposition (ALD) have high strength and maintain their structures even in a fluid.

Furthermore, the density of the three-dimensional carbon nanotube networks can be adjusted by varying the spacing between silicon pillars on which carbon nanotubes are synthesized. Therefore, the microfluidic filter of the present invention can filter particles having a desired size.

### DESCRIPTION OF DRAWINGS

FIG. 1 is a flow chart illustrating a silicon wafer etching process for synthesizing three-dimensional carbon nanotube networks used in a microfluidic filter of the present invention.

FIG. 2 shows cross-sectional images of silicon pillars designed to have different spacings after etching.

FIG. 3 is a schematic diagram showing a process for synthesizing three-dimensional carbon nanotube networks used in a microfluidic filter of the present invention.

FIG. 4 shows images of three-dimensional carbon nanotube networks synthesized in accordance with a method of the present invention.

FIG. 5 shows images of three-dimensional carbon nanotube networks that have different densities depending on the spacing between silicon pillars.

FIG. 6 shows images of three-dimensional carbon nanotube networks used in a microfluidic filter of the present invention before and after a fluid was allowed to flow through the three-dimensional carbon nanotube networks.

FIG. 7 shows images of carbon nanotubes coated with Al₂O₃ by atomic layer deposition (ALD) to increase the strength of the carbon nanotubes in accordance with a method of the present invention wherein Al₂O₃ were uniformly coated on the surface of the carbon nanotubes by ozone treatment.

FIG. 8 is a side image of three-dimensional carbon nanotube networks after coating by atomic layer deposition (ALD) in accordance with a method of the present invention.

FIG. 9 is a transmission electron microscopy (TEM) image of carbon nanotubes coated with Al₂O₃ by atomic layer deposition (ALD) to increase the strength of the carbon nanotube in accordance with a method of the present invention.

FIG. 10 is a conceptual diagram illustrating a microfluidic chip system according to the present invention.

FIGS. 11a and 11b are optical microscopy (CCD) and scanning electron microscopy (SEM) images of a microfluidic filter according to the present invention, respectively.

FIG. 12 shows SEM images comparing a filter without carbon nanotubes and a filter with carbon nanotube networks.

FIG. 13 shows images showing filtering effects depending on the spacing between pillars.

FIG. 14 is a SEM image showing particles filtered by carbon nanotubes.

FIG. 15 shows a SEM image of three-dimensional carbon nanotube networks and a partially magnified image thereof.

### BEST MODE

The present invention will now be described in more detail with reference to the following embodiments.

In an aspect, the present invention provides a microfluidic filter including three-dimensional carbon nanotube networks coated with a metal oxide wherein the density of the three-dimensional carbon nanotube networks is adjustable such that the filtering size is controlled.

In another aspect, the present invention provides a method for preparing a microfluidic filter using three-dimensional carbon nanotube networks, the method including: forming silicon pillars on a silicon substrate; dipping the silicon substrate in a bimetallic catalyst solution to allow the metal catalysts to be uniformly adsorbed onto the substrate; supplying a carbon source gas to the substrate onto which the catalysts are adsorbed, to form three-dimensional carbon nanotube networks between the silicon pillars; and coating a metal oxide on the three-dimensional carbon nanotube networks by atomic layer deposition.

### MODE FOR INVENTION

Reference will now be made in greater detail to embodiments of the present invention.

The microfluidic filter of the present invention includes three-dimensional carbon nanotube networks coated with a metal oxide and is characterized in that the density of the three-dimensional carbon nanotube networks can be adjusted such that the filtering size can be controlled.

Specifically, the three-dimensional carbon nanotube networks used in the present invention grow horizontally in parallel between silicon pillars formed on a silicon substrate to form a plurality of carbon nanotube bridges. The density (number) of the three-dimensional carbon nanotube networks per unit space of is at least 1.5 μm³, and the density (number) of the carbon nanotube bridges formed between a pair of the silicon pillars per unit height of the silicon pillars is at least 3/μm. That is, the carbon nanotubes grown horizontally in parallel and suspended between the silicon pillars are highly dense (i.e. large in number) per unit space.

Three-dimensional carbon nanotube networks without surface modification are so weak that the network structures cannot be maintained in fluids. For this reason, the three-dimensional carbon nanotube networks used in the present invention are coated with a metal oxide by atomic layer deposition. This coating can increase the mechanical strength of the three-dimensional carbon nanotube networks. Particularly, atomic layer deposition (ALD) is a useful process for stacking three-dimensional structures on the order of 10⁻¹⁰ m. Examples of metal oxides suitable for use in the present invention include Al₂O₃, HfO₂, ZrO₂, ZnO₂, and CuOₓ. These metal oxides can be suitably selected according to their characteristics.

The method of the present invention includes: forming silicon pillars on a silicon substrate; dipping the silicon substrate in a bimetallic catalyst solution to allow the metal catalysts to be uniformly adsorbed onto the substrate; supplying a carbon source gas to the substrate onto which the catalysts are adsorbed, to form three-dimensional carbon nanotube networks between the silicon pillars; and coating a metal oxide on the three-dimensional carbon nanotube networks by atomic layer deposition.

The method of the present invention is characterized in that the density of the three-dimensional carbon nanotube networks is adjusted by varying the height of the silicon pillars and the spacing between the silicon pillars such that the filtering size can be controlled. The method of the present invention is characterized in that the three-dimensional carbon nanotube networks can be highly densely and uniformly formed in the base portions of the silicon pillars as well as in the outermost portions thereof.

The spacing between the silicon pillars may be, for example, in the range of 10 nm to tens of μm but is not particularly limited to this range.

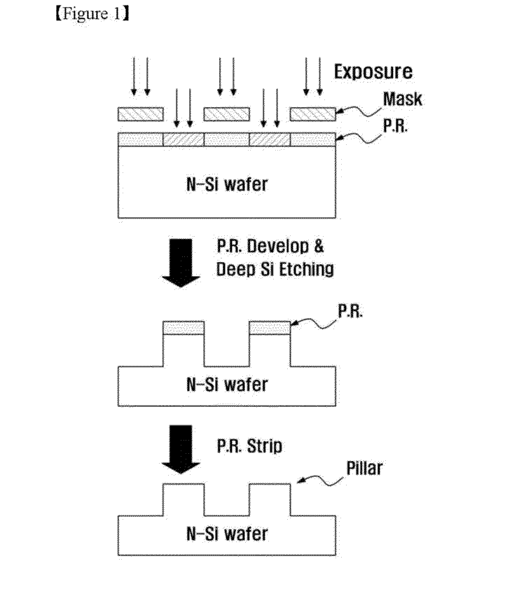

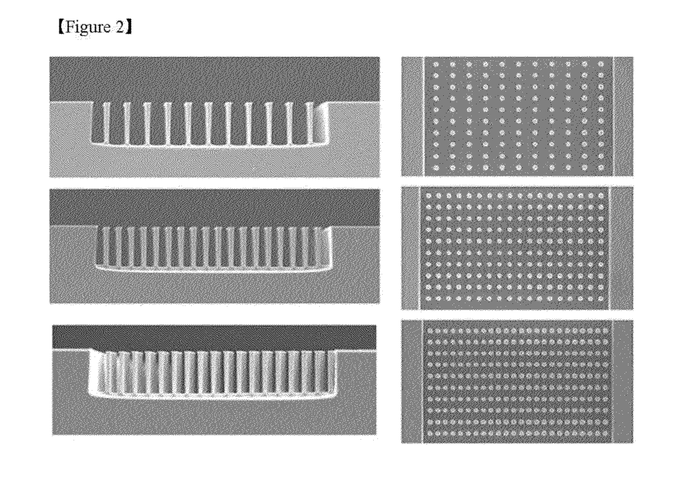

Referring to FIGS. 1 and 2, first, (a) a silicon substrate is etched to form silicon pillars. This etching provides a three-dimensional structure. No particular limitation is imposed on the etching process. The silicon substrate may be etched by any suitable process known in the art, for example, the Bosch process. Next, (b) metal catalyst particles are introduced onto the three-dimensionally structured substrate by liquid dipping, and then (c) a carbon source gas is supplied to the substrate onto which the metal catalyst particles are introduced, to form carbon nanotubes having three-dimensional network bridge structures.

A direct growth process may also be used in which a catalyst is formed on the Si substrate and a Si source is supplied to grow Si pillars on the Si substrate.

For example, carbon nanotubes may be produced by CVD using a metal catalyst. In this case, a substrate on which the carbon nanotubes grow should not be sintered together with the metal catalyst when heat is applied to grow the carbon nanotubes. Specifically, when a silicon substrate and Fe as a metal catalyst are used, they are sintered together to form FeₓSi_{y} during growth of carbon nanotubes. As a result, the catalyst loses its activity for the growth of carbon nanotubes, leading to low density of grown carbon nanotubes. In consideration of this limitation, most prior art processes use silica (SiO₂) substrates rather than silicon substrates. The surface of silicon pillars formed by etching of silica as a nonconductor is also electrically non-conductive.

In contrast, according to the present invention, the catalysts are protected from inactivation despite direct use of the silicon substrate, enabling the growth of three-dimensional carbon nanotube networks in high density even in the base portions of the silicon pillars. The three-dimensional carbon nanotube networks are directly connected to the silicon pillars acting as base electrodes. This connection is advantageous in terms of conductivity.

The reason why the Fe metal particles are prevented from sintering despite the direct use of the silicon substrate is believed to be because the Mo metal acts as a barrier to the sintering. There is no restriction on the composition of the Fe—Mo catalyst solution. In one embodiment of the present invention, the Fe—Mo catalyst solution may include Fe(NO₃)₃.9H₂O and an aqueous solution of Mo.

The silicon pillars may be formed on the silicon substrate by any suitable method commonly used in the art. Examples of such methods include, but are not particularly limited to, electrochemical etching, photolithography, and direct synthesis.

There is no particular restriction on the height and shape of the silicon pillars and the spacing between the silicon pillars. Preferably, the height of the silicon pillars is from 2 to 200 μm, the spacing between the silicon pillars is from 50 to 2000 nm, and the aspect ratio of the silicon pillars is from 2 to 100. Within these ranges, three-dimensional networks of carbon nanotubes can be formed. If the silicon pillars are low below 2 μm, the spaces defined by the silicon pillars are too small to form three-dimensional networks of carbon nanotubes. Meanwhile, if the silicon pillars are high above 200 μm, there is the risk that carbon nanotubes may not be uniformly formed in the base portions of the silicon pillars. If the spacing between the silicon pillars is less than 50 nm, the silicon pillars are too close to form carbon nanotubes. Meanwhile, if the spacing between the silicon pillars exceeds 2000 nm, the silicon pillars are too far away from each other, posing a risk that carbon nanotube bridge networks may be difficult to form.

It is necessary to limit the aspect ratio of the silicon pillars in order to improve the density of three-dimensional carbon nanotube networks per unit space. If the silicon pillars have an aspect ratio lower than 2 or higher than 100, there is the risk that the density of carbon nanotubes may decrease.

After the formation of the silicon pillars on the silicon substrate, the resulting structure is cleaned with solvents, such as acetone, ethanol, and deionized water, and is then treated with a piranha solution, UV-ozone or oxygen plasma to modify the surface into Si—OH. The functional groups (—OH groups) formed on the surface of the silicon pillars interact with the metal catalysts or the catalyst ions to prevent the metal catalysts from being separated from the surface of the silicon pillars in the subsequent cleaning step. The piranha solution is a mixture of sulfuric acid and hydrogen peroxide.

The molar concentration ratio of Fe to Mo in the Fe—Mo catalyst solution is preferably from 10:1 to 1:1. If the Mo proportion is less than the lower limit (10:1), the Fe is sintered and is thus inactivated, resulting in low density of carbon nanotubes. Meanwhile, if the Mo proportion is greater than the upper limit (1:1), the Mo cannot function as a seed for the growth of carbon nanotubes, posing a risk of low density of carbon nanotubes.

In one embodiment of the present invention, the Fe—Mo catalyst solution may be a mixture of an ethanolic solution of Fe(NO₃)₃.9H₂O and an aqueous solution of Mo. The step of dipping the Si substrate in the catalyst solution may also be carried out in combination with sonication. This combination permits uniform adsorption of the metal catalysts onto the Si substrate.

The method of the present invention may further include annealing the substrate, onto which the bimetallic catalyst is adsorbed, in a reactor, and supplying NH₃ or hydrogen gas to the reactor to reduce the metal catalysts. The annealing is performed under vacuum or a gas atmosphere containing oxygen. Typically, the annealing may be performed at a temperature of about 300 to about 500° C. for 10 to 60 minutes. The reasons for the annealing are to remove organic/inorganic chemical substances attached to the metal catalysts and the substrate and to oxidize the surface of the catalyst particles. This oxidization inhibits the mobility of the metal catalysts at high temperatures, which prevents metal catalysts from the aggregation.

The metal catalysts are not sufficiently annealed at a temperature lower than 300° C., and excessive thermal energy is created at a temperature higher than 500° C. to activate the thermal motion of the metal catalysts, posing the risk of aggregation. The oxygen-containing gas atmosphere for annealing is advantageous in removing organic chemical substances but increases the risk that the surface of the silicon substrate may be oxidized. Despite this risk, the short annealing time minimizes the amount of the silicon oxidized to a negligible level.

Next, hydrogen or NH₃ gas is supplied to the reactor to reduce the metal catalyst oxides formed on the surface of the substrate as a result of the annealing. Specifically, after the annealing, the reactor is heated to about 700 to about 900° C. while reducing the pressure of the reactor to 10 torr or less. For example, hydrogen or ammonia gas may be supplied to the reactor when the reactor is stabilized at about 800° C. Alternatively, the gas may be supplied while heating the reactor temperature. The pressure and temperature of the reactor are not limited to the ranges defined above.

After the metal catalysts are reduced, a carbon source gas is supplied to the reactor to produce carbon nanotubes. No limitation is imposed on the kind of the carbon source gas. The carbon source gas may be any of those commonly used in the art. For example, the carbon source gas may be selected from the group consisting of methane, ethylene, acetylene, benzene, hexane, ethanol, methanol, propanol, and mixed gases thereof.

The carbon nanotubes are generally single-walled carbon nanotubes, but are not necessarily limited thereto. For example, multi-walled carbon nanotubes may also be formed. Multi-walled carbon nanotubes with improved conductivity are advantageous. However, the formation of multi-walled carbon nanotubes tends to decrease the number of networks.

In the three-dimensional carbon nanotube networks formed in accordance with the present invention, at least ten carbon nanotube bridges are preferably formed between the two adjacent silicon pillars. As the density of the carbon nanotubes per unit space increases, the electrical conductivity and surface area increase, thus making the three-dimensional carbon nanotube networks suitable for use in the filter.

The carbon nanotubes thus synthesized are treated with ozone by atomic layer deposition (ALD). The ozone treatment converts the hydrophobic carbon nanotubes into hydrophilic ones. Specifically, the carbon nanotubes are exposed to ozone using an atomic layer deposition system to modify the surface with —OH (hydrophobic).

The coating of the three-dimensional carbon nanotube networks with a metal oxide, such as Al₂O₃, by atomic layer deposition (ALD) leads to an increase in the strength of the three-dimensional networks, which can maintain the three-dimensional network structures even in a fluid. Therefore, the metal oxide coating enables the use of the three-dimensional carbon nanotube networks in the microfluidic chip of the present invention.

The present invention will be explained in more detail with reference to the following examples. However, these examples are provided to assist in a further understanding of the invention and are not intended to limit the scope of the invention.

### Example 1

### Synthesis of Three-Dimensional Carbon Nanotube Networks with Different Densities According to Spacing Between Silicon Pillars

The present invention is characterized in that three-dimensional carbon nanotube networks with various densities can be synthesized depending on the spacing between silicon pillars and the height of silicon pillars even under the same conditions. A p-type Si wafer was etched by general photolithography and the Bosch process to form silicon pillars having a height of 28 μm and a diameter of about 3 μm. The silicon pillars were spaced apart from each other at intervals of 2.65 μm and 4.25 μm. Next, the etched Si wafer was cleaned with acetone, ethanol and deionized water, treated with piranha solution for 30 min to modify the surface with —OH, and washed with deionized water. Then, an ethanolic solution of Fe(NO₃)₃.9H₂O (Junsei) was mixed with an aqueous solution of Mo (ICP/DCP standard solution, 10 mg/mL Mo in H₂O, Aldrich) to prepare a bimetallic catalyst solution. The molar concentration ratio of Fe to Mo in the bimetallic catalyst solution was 4:1.

Then, the surface-modified Si wafer was dipped in the bimetallic catalyst solution. As a result of the dipping, the catalysts were uniformly adsorbed onto the entire surfaces of the wafer and the silicon pillars. The Si wafer, onto which the catalysts are adsorbed, was cleaned with ethanol and mounted in a horizontal quartz tube reactor. The Si wafer, onto which the catalysts are adsorbed, was annealed in air at 400° C. for 30 min. The reactor was heated to 800° C. while maintaining the pressure at 1.0×10 Torr or less. Then, the reactor was stabilized at a temperature of 800° C. 300 seem of NH₃ gas was fed into the reactor for 10 min to reduce the metal oxide catalysts to their pure metal catalysts.

Finally, 20 sccm of C₂H₂ as a carbon source gas was supplied to the reactor for 10 min to form three-dimensional networks of single-walled carbon nanotubes. At this time, the internal pressure of the reactor was 3.3×10 Torr. The two patterns having different spacings on the single substrate were tested under the same conditions. It was confirmed that the density of the three-dimensional networks was adjustable by the spacing between the pillars. These newly observed results demonstrate the synthesis of the three-dimensional carbon nanotubes. After cooling to room temperature, the Si wafer was taken out of the reactor.

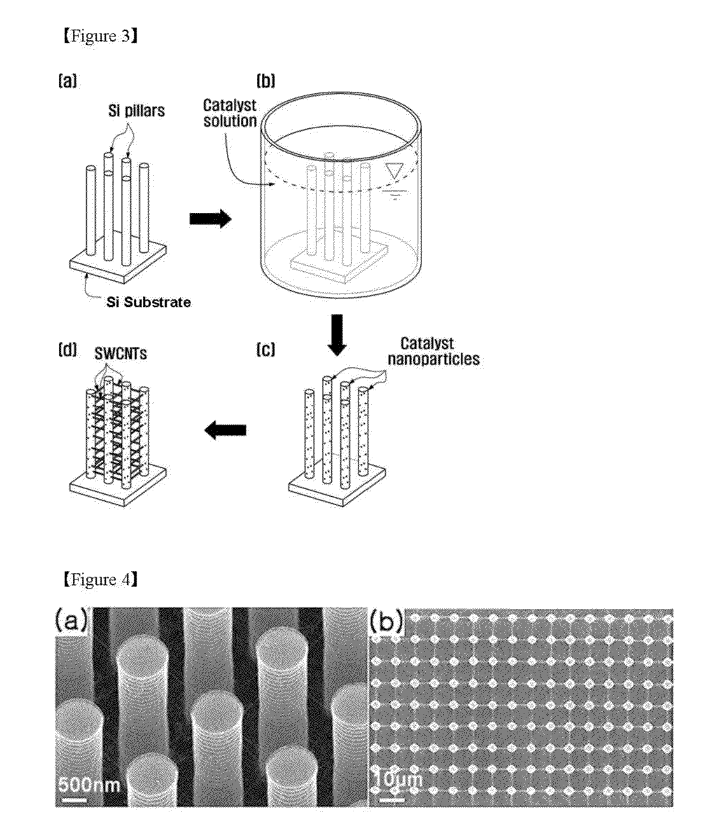

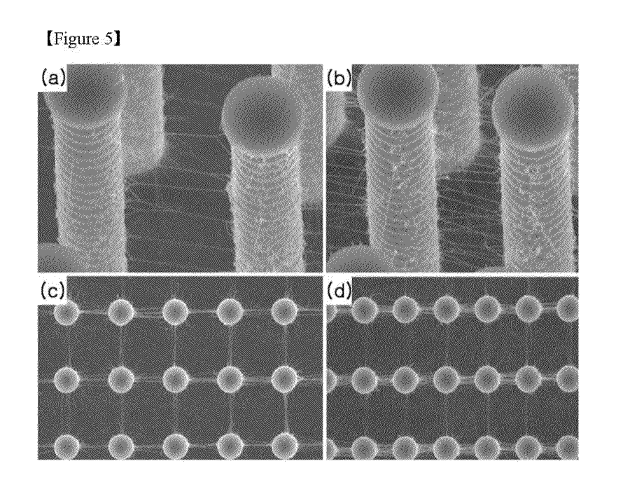

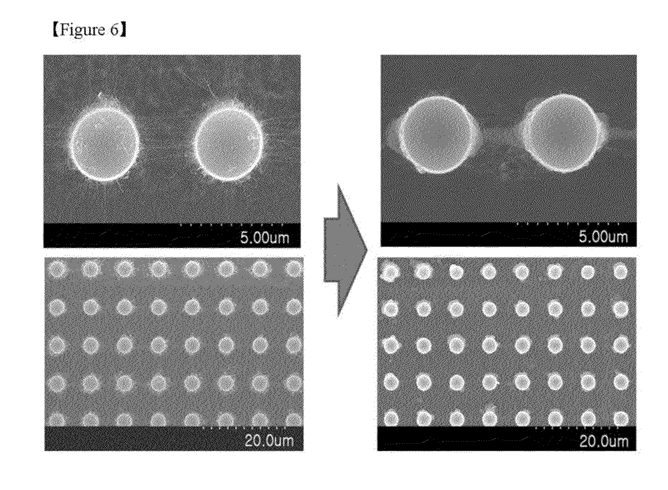

FIG. 1 illustrates a silicon wafer etching process for synthesizing the three-dimensional carbon nanotube networks. FIG. 3 shows a process for synthesizing the three-dimensional carbon nanotube networks. FIG. 2 shows cross-sectional images of the silicon pillars designed to have different spacings after etching. FIG. 4 shows images of the synthesized three-dimensional carbon nanotube networks.

### Example 2

### Ozone Treatment by Atomic Layer Deposition (ALD)

The hydrophobic carbon nanotubes were treated with ozone by atomic layer deposition (ALD). The ozone treatment converted the hydrophobic carbon nanotubes into hydrophilic ones. An atomic layer deposition system (Cyclic 4000, Genitech, Taejon, Korea) was used, and Ar gas was used as a carrier or purging gas to move two substances. Oxygen was fed and a UV lamp was turned on for 360 sec to generate ozone to which the carbon nanotubes were exposed. As a result of the ozone treatment, the surface of the carbon nanotubes was modified with —OH (hydrophobic).

### Example 3

### Al₂O₃ Coating by Atomic Layer Deposition (ALD)

The synthesized three-dimensional carbon nanotube networks were coated with Al₂O₃ by atomic layer deposition (ALD). The Al₂O₃ coating led to an increase in the strength of the three-dimensional networks, which maintained the three-dimensional network structures even in a fluid. The three-dimensional carbon nanotube networks having undergone Al₂O₃ coating were used to prepare a microfluidic chip.

After the sample was placed in an ALD chamber, the surface of the carbon nanotubes was exposed to Al(CH₃)₃ and water. The exposure was conducted at 30° C. and 20° C. At each temperature, Al(CH₃)₃ was purged for 2 sec, Ar was purged for 20 sec, water was fed for 1 sec, and Ar was purged for 5 sec. After completion of the reaction, Ar was allowed to flow to maintain the pressure at 300 mTorr.

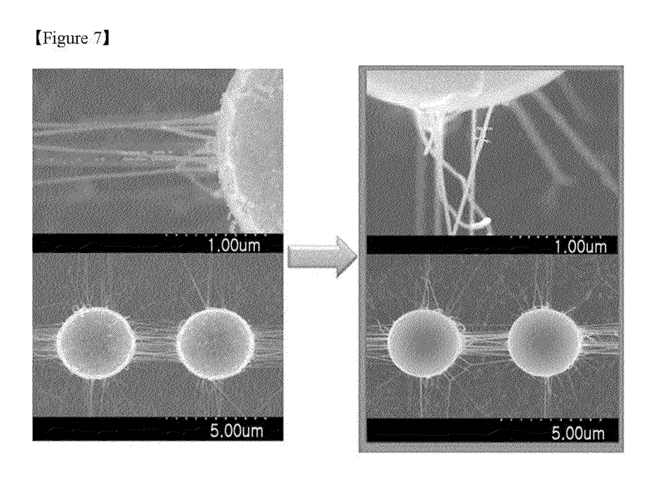

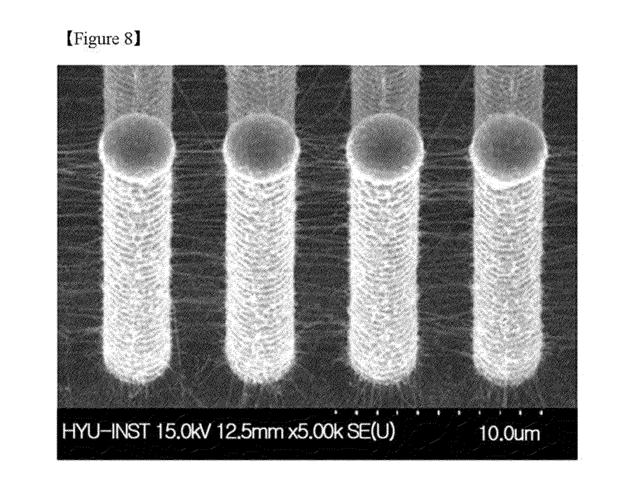

FIGS. 7 and 8 show front and side images of the three-dimensional carbon nanotube networks after ALD coating, respectively. FIG. 9 is a TEM image of the carbon nanotubes coated with Al₂O₃ by atomic layer deposition (ALD).

### Experimental Example 1

### Test on Microfluidic Filter

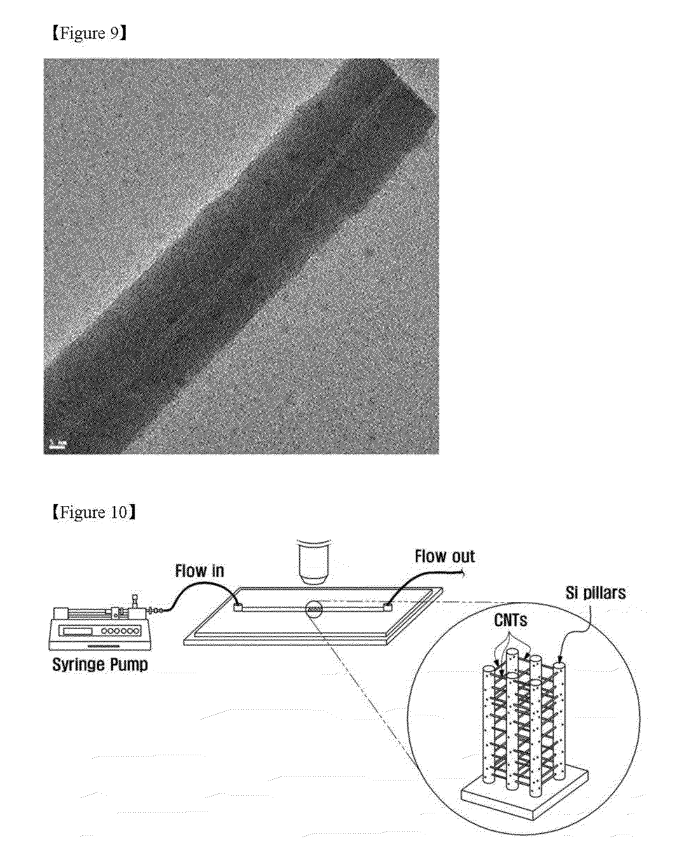

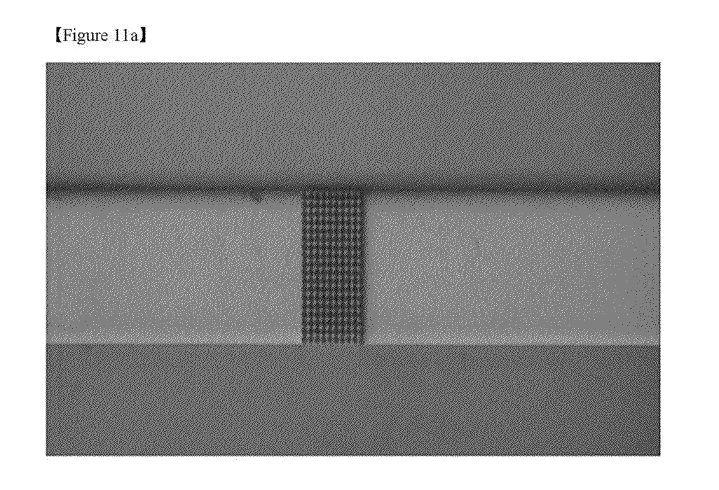

FIG. 10 illustrates a microfluidic chip system. The system was constructed by using three-dimensional carbon nanotube networks as filters. The system was tested for filtering ability. Specific conditions of the microfluidic chip used in this experiment are as follows:

Silicon substrate: area=150 μm, height=28.5 μm, length=2 mm

Entire length of each pillar=84 μm, spacings between the pillars=4.25 μm and 2.65 μm

Flow rate=0.01 μL/min, Flow velocity=40 μm/s

Solutions: ethanol+(500 nm green fluorescent polystyrene particles), ethanol+(1000 nm red fluorescent polystyrene particles)

Specifically, the system was tested by the following procedure. First, the surface of the system was treated with UV—O₃ and covered with a PDMS thin film. A syringe pump (Pump 11 Pico Plus, Harvard Apparatus) was connected to a microfluidic substrate (LabSmith), and an ethanolic dispersion of aqueous fluorescent microspheres (G500, Duke Scientific Corporation) was fed into the system. The spheres had a diameter of 500 nm and were allowed to flow at a rate of 0.01 μL/min (flow velocity 40 μm/s).

Images of the fluidic chip were taken using a fluorescence microscope (BX51, Olympus) equipped with a 20× magnification lens and a CCD camera (DP70, Olympus).

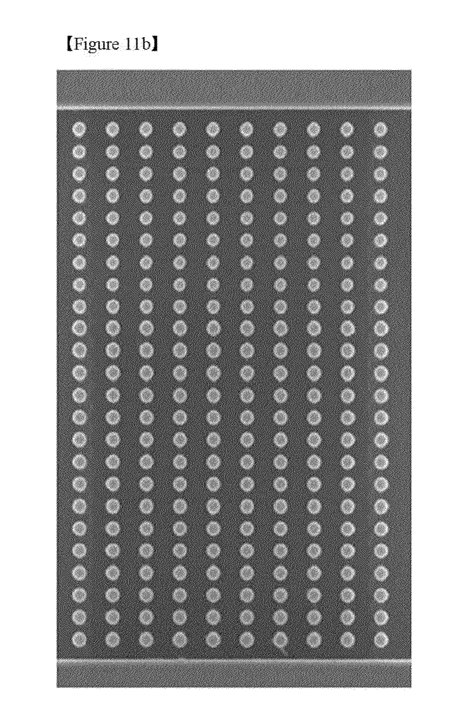

FIGS. 11a and 11b are the CCD image and the SEM image of the silicon pillars in the microfluidic chip, respectively. Since the density of the carbon nanotube networks was adjusted by varying the spacing between the pillars, the pillars were designed to have different spacings in the microfluidic channels, followed by etching.

FIGS. 7 and 8 show test results for the strength of the three-dimensional carbon nanotube networks in a fluid. In the three-dimensional carbon nanotube networks having undergone no ALD coating, the carbon nanotubes were physically bonded to the silicon pillars. Since the strength of the three-dimensional networks was weaker than the flow pressure, the structures were not maintained in the fluid. (FIG. 7) The ALD coating improved the strength of the three-dimensional carbon nanotube networks, enabling the networks to maintain their structures even in the fluid. (FIG. 8)

Based on the fact that the density of the filter can be adjusted by varying the spacing between the pillars, the present invention can provide a filter for a microfluidic chip having an appropriate density for the size of substances to be filtered. FIG. 5 shows images of the carbon nanotubes coated with Al₂O₃ by ALD. The spacings between the pillars were 4.25 μm ((a) and (c)) and 2.65 μm ((b) and (d)). FIG. 5 confirms that the number of the channels decreased with increasing pillar spacing, resulting in an increase in the area of each channel.

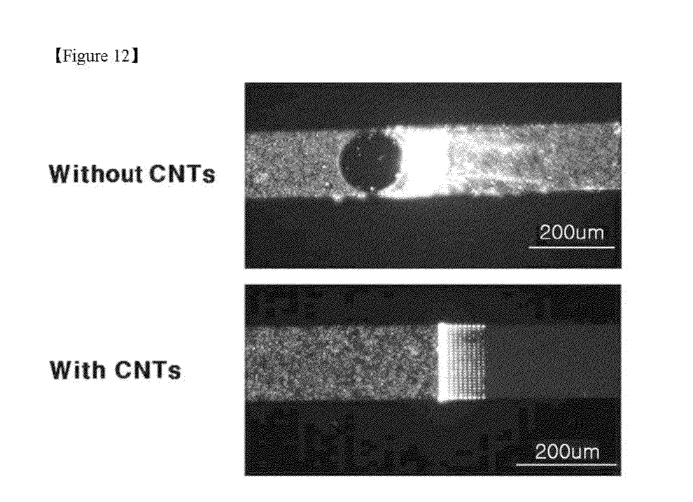

FIG. 12 shows SEM images comparing a filter without carbon nanotubes and a filter with carbon nanotube networks.

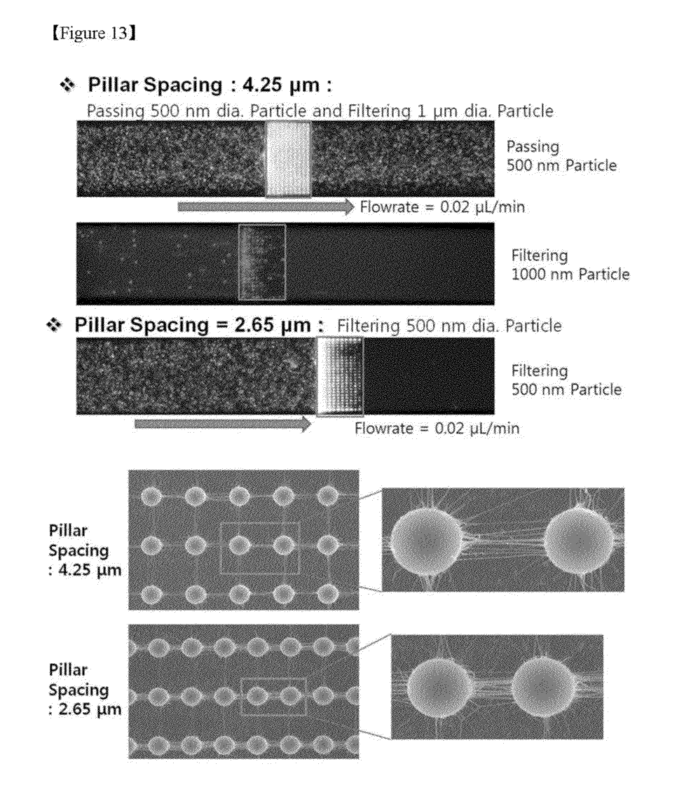

FIG. 13 shows images showing filtering effects depending on the spacing between the pillars. As shown in FIG. 13, the fluorescent particles having a diameter of 500 nm were passed through the three-dimensional carbon nanotube networks with a pillar spacing of 4.25 μm but were filtered by the three-dimensional carbon nanotube networks with a pillar spacing of 2.65 μm. The red fluorescent particles having a diameter of 1 μm (1000 nm) were filtered by the three-dimensional carbon nanotube networks with a pillar spacing of 4.25 μm.

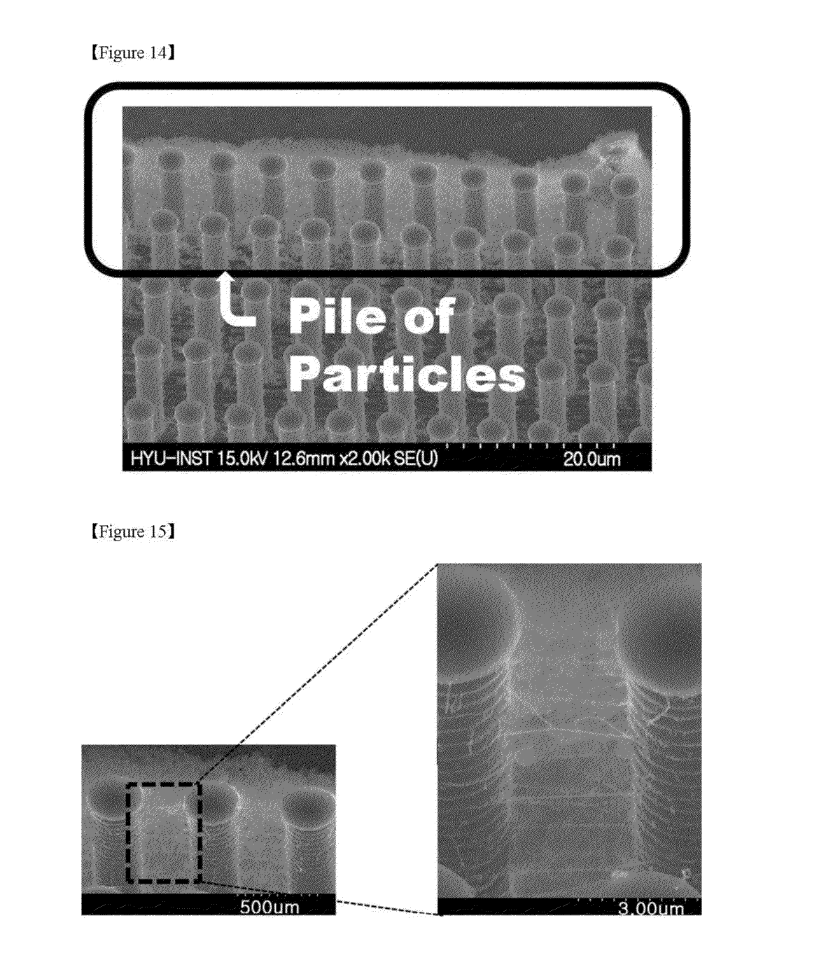

FIG. 14 is a SEM image showing the particles filtered by the carbon nanotubes. FIG. 14 demonstrates that the particles were filtered by the carbon nanotube networks, not by the silicon pillars. FIG. 15 shows a SEM image of the three-dimensional carbon nanotube networks and a partially magnified image thereof.

### INDUSTRIAL APPLICABILITY

As is apparent from the foregoing, the microfluidic filter of the present invention has a controllable filtering size. Therefore, the microfluidic filter of the present invention can be applied to chips for disease diagnosis in the pharmaceutical research field. In addition, the microfluidic filter of the present invention can be used for testing of micro-units.

1. A microfluidic filter comprising three-dimensional carbon nanotube networks coated with a metal oxide wherein the density of the three-dimensional carbon nanotube networks is adjustable such that the filtering size is controlled.

2. The microfluidic filter according to claim 1, wherein the three-dimensional carbon nanotube networks grow horizontally in parallel between silicon pillars formed on a silicon substrate to form a plurality of carbon nanotube bridges.

3. The microfluidic filter according to claim 1, wherein at least ten carbon nanotube bridges are formed horizontally between the two adjacent silicon pillars to form the three-dimensional networks.

4. The microfluidic filter according to claim 1, wherein the metal oxide is selected from Al₂O₃, HfO₂, ZrO₂, ZnO₂, and CuOₓ.

5. A method for preparing a microfluidic filter using three-dimensional carbon nanotube networks, the method comprising:
forming silicon pillars on a silicon substrate;
dipping the silicon substrate in a bimetallic catalyst solution to allow the metal catalysts to be uniformly adsorbed onto the substrate;
supplying a carbon source gas to the substrate onto which the catalysts are adsorbed, to form three-dimensional carbon nanotube networks between the silicon pillars; and
coating a metal oxide on the three-dimensional carbon nanotube networks by atomic layer deposition,
wherein the density of the three-dimensional carbon nanotube networks is adjusted by varying the height of the silicon pillars and the spacing between the silicon pillars such that the filtering size is controllable.

6. The method according to claim 5, wherein the bimetallic catalyst is a Fe—Mo catalyst

7. The method according to claim 5, wherein the molar concentration ratio of Fe to Mo in the Fe—Mo catalyst solution is from 10:1 to 1:1.

8. The method according to claim 5, further comprising annealing the substrate onto which the bimetallic catalyst is adsorbed, and supplying NH₃ or hydrogen gas to the annealed substrate to reduce the metal catalysts.

9. The method according to claim 5, wherein the carbon source gas is selected from the group consisting of methane, ethylene, acetylene, benzene, hexane, ethanol, methanol, propanol, and mixed gases thereof.

10. The method according to claim 5, wherein the metal oxide is selected from Al₂O₃, HfO₂, ZrO₂, ZnO₂, and CuOₓ.
